(19) United States
(12) Patent Application Publication
(10) Pub. No.: US 2017/0297940 A1
(43) Pub. Date: Oct. 19, 2017

(54) METHOD FOR A TREATMENT OF WATER BY ADSORPTION ON ACTIVE CARBON AND CLARIFICATION, AND CORRESPONDING PLANT

(71) Applicant: Veolia Water Solutions & Technologies Support, Saint-Maurice Cedex (FR)

(72) Inventors: Philippe SAUVIGNET, Saint-Etienne en Cogles (FR); Abdelkader GAID, Paris (FR)

(73) Assignee: Veolia Water Solutions & Technologies Support, Saint-Maurice Cedex (FR)

(21) Appl. No.: 15/486,366

(22) Filed: Apr. 13, 2017

(30) Foreign Application Priority Data
Apr. 13, 2016 (FR) 1653262

(51) Int. Cl. C02F 9/00; B01D 21/24; B01D 21/32; B01J 20/20; B01J 20/28; B01D 15/02; B01J 20/34; C02F 1/28; C02F 1/52; C02F 1/00; C02F 101/30

(52) U.S. Cl. CPC C02F 9/00; B01J 20/3483; B01D 21/245; B01D 21/32; B01J 20/20; B01J 20/28004; B01J 20/28016; B01J 20/28064; B01D 15/02; B01J 20/3416; C02F 1/283; C02F 1/52; C02F 2001/007; C02F 2101/305; C02F 2101/306; C02F 2303/18; C02F 2305/12

(57) ABSTRACT

Method and plant for treating water implementing a contact vessel (21) for putting water into contact with a granular adsorbent material and a clarification, granular adsorbent material is constituted by agglomerates of active carbon particles, said agglomerates having an average size of 200 μm to 600 μm and a specific surface area of 800 to 1000 m²/g, a screen (9) being provided in the upper part of the contact vessel (21) comprising a layer of porous material having a thickness of 1 to 5 mm and a cut-off threshold of 100 μm to 200 μm, said contact vessel (21) having a hopper-shaped lower part (21a), purging means (21b) and stirring means (22) to stir the content of the upper part of this contact vessel (21) without stirring the content of the lower hopper-shaped part.

### TECHNICAL FIELD OF THE INVENTION

The invention relates to the field of water treatment. More specifically, the invention relates to methods for treating water implementing at least one treatment step during which the water is put into contact with adsorbent inert granular carbon material with a view to reducing its content in organic matter and pollutants (pesticides, micropollutants, endocrine disruptors, industrial residues, medicinal residues etc.) followed by a step of clarification.

### PRIOR ART

Inert carbon materials in powder or granular form are endowed with highly developed intrinsic porosity that confers on them a large specific surface area which gives them the property of adsorbing large quantities of organic molecules and of catalyzing reactions. In practice, the adsorption capacity of a granular adsorbent material can be evaluated by measuring its iodine index. Adsorption capacity evaluated by the measurement of the iodine index indicates the quantity of iodine, expressed in milligrams, adsorbed per gram of powdered activated carbon. This measurement of the iodine index can especially be done according to the international ASTM no. D4607.

Powdered activated carbon used in the context of water treatment methods has an average particle size of 10 μm to 50 μm and a specific surface area corresponding to an iodine index of 800 to 1000 mg/g of PAC (index measured according to the standard indicated here above).

In the context of such methods, PAC can be implemented according to different configurations.

Thus, the PAC can be added to the water to be treated in a reactor for a contact time sufficient to enable the adsorption of the organic matter that it contains. The PAC, charged with the matter adsorbed in it, must then be separated from the treated water by clarification, This clarification step is generally implemented by settling or decanting or by membrane separation.

Coagulant reagents and/or flocculent reagents are conventionally added to favor aggregation of the organic material and the PAC in the form of flocs and thus facilitate the clarification operation.

Since PAC is very costly, steps are taken to recycle this material. For this purpose, the sludge retrieved at the end of the above-mentioned clarification, containing adsorbent material, is processed so as to remove the essential part of the aqueous phase from it. The step is generally implemented by hydrocyclone treatment. At the end of this step, in an underflow from the hydrocyclone, a phase containing powdery adsorbent material is obtained and can be reintroduced into the water treatment method. In practice, this phase contains a high proportion of powdery material or again water and takes the form of a relatively fluid sludge. The essential part of the aqueous phase of the sludge coming from the separation step indicated here above will have however been eliminated in an overflow from the hydrocyclone.

One example of such a prior art method is described in the French patent application FR-A-2868064.

According to this prior art, the hydrocyclone step rids the powdery material recycled on site step not of all the organic material adsorbed on it but only of a small part of this organic material, Although recycled on site, the adsorbent material gradually has its adsorbent capacity diminished. It is thus necessary to regularly replace a part of the PAC used in the reactor with fresh PAC. Quantities of fresh PAC must therefore at the same time be injected regularly into the reactor to compensate for the loss of adsorption capacity of the used PAC. Although this type of method authorizes the replacement of a part of the used PAC with fresh PAC without having to stop the plants that implement it, it nevertheless has other drawbacks.

Thus, the PAC that comes from the purging of the system is riot necessarily regenerated in that there is no known and economically efficient treatment that would give the PAC back its original adsorbent capacity or adsorbent capacity close to this original capacity. This causes a production of CAP sludge that must be discharged out of the plant. The processing of this sludge has some drawbacks, In particular, the sludge must be dehydrated before it is transported. This increases the cost associated with its discharge or its incineration or its use for agricultural spraying.

Since PAC is a costly material, its use in water treatment clashes with economic imperatives. The techniques that implement PAC therefore have the drawback of entailing high operating costs,

In addition, the treatment of water by PAC in practice implies the addition of major quantities of coagulants such as FeCl₃, and/or flocculants, such as polymers enabling the formation of sufficiently dense flocs. This is done in order to promote settling or decanting and also avoid leakages of PAC which would lower the quality of the refining treatment operations, such as filtration, planned downstream. It is also common practice to add micro-ballast such as micro-sand in order to accelerate the decanting process. The use of polymers can lead to accelerated saturation of PAC, forcing the user to renew it more frequently. Above all, the use of these products leads to increased volumes of sludge that have to be treated in parallel systems. In practice, this sludge must be thick, dehydrated and discharged outside the production site. The operating costs of such methods are thereby also increased. In any case, this PAC sludge cannot be treated in such a way as to enable regenerated PAC to be obtained.

Goals of the Invention

The goal of the present invention is to propose a method for treating water in order to eliminate organic material and pollutants therefrom, wherein the water is put into contact with a contact vessel with adsorbent material and clarified by avoiding the problems of the prior art resulting from the presence of adsorbent material in the water during its clarification.

It is a goal of the present invention to propose a method of this kind that minimizes the quantity of sludge resulting from the clarification.

It is another goal of the present invention to describe a method of this kind that minimizes the quantities of polymer when the clarification uses such a material.

It is yet another goal of the present invention to disclose a method of this kind according to which the adsorbent material can be renewed without having to interrupt the treatment.

It is also a goal of the present invention to disclose a method of this kind that can be used to maintain a level of treatment of water that is essentially constant in time.

It is also a goal of the present invention to propose a method of this kind which, in at least one its embodiments, results in to a used adsorbent material that can be directly refreshed, i.e. the adsorption capacity of which, relative to the organic material, can be easily restored.

Thus, it is a goal of the present invention to present a method of this kind which, in at least one of its embodiments, restores 50% of the adsorption capacity of the adsorbent material, i.e, makes it possible to obtain an at least partially regenerated adsorption material, the adsorption capacity of which corresponds to at least 50% of that of the same adsorbent material when fresh.

It is another goal of the present invention to describe a method of this kind that induces treatment costs smaller than those of the prior art methods, for appreciably equal levels of treatment,

It is another goal of the present invention to propose a plant for implementing such a method,

It is yet another goal of the invention to disclose a plant of this kind that can result from the rehabilitation of existing old stations.

### SUMMARY OF THE INVENTION

These different goals are attained by means of a method for treating water with a view to reducing its content in organic matter and pollutants, said method comprising:

a step for putting water to be treated into contact with a granular adsorbent material in a contact vessel provided with stirring means;

followed by a step for clarifying water coming from said vessel leading to the obtaining of clarified water and sludge;

characterized in that

said granular adsorbent material is constituted by agglomerates of active carbon particles, said agglomerates having an average size of 200 μm to 600 μm and a specific surface area of 800 to 1000 m²/g, said granular adsorbent material regenerable by thermal means;

said water being filtered on a screen when exiting said vessel, before undergoing clarification, in order to retain said adsorbent granular material within said vessel while at the same time not retaining the non-adsorbed organic material on said adsorbent material,

and in that

the content of said contact vessel is stirred only partially so as to create a gradient of concentration of said adsorbent material within it, the bottom of said contact vessel constituting a non-stirred area;

used adsorbent granular material being purged continuously or intermittently from said non-stirred area of said contact vessel in order to be regenerated extemporaneously by thermal means, and replaced by fresh adsorbent granular material.

Thus, according to the invention, there is no need for any on-site recycling of said granular adsorbent material.

The adsorbent material used within the framework of the method according to the invention is a commercially available material that is therefore not a PAC as understood in the field of water treatment. Indeed, it has a higher specific surface area than PAC. Also, it is not a granular activated carbon (GAC) as understood in the field of water treatment. It has in fact a lower particle size.

Such a specific adsorbent material has, among other advantages, that of being regenerable by thermal means unlike the PACs classically used in the field of water treatment which cannot be regenerated.

According to the invention, this material is kept in the contact vessel through appropriate means, thus preventing its propagation during the step of clarification and preventing any risk of dissemination of this material into clarified water. These means retain the adsorbent material in the contact vessel while at the same time letting through water and organic matter and pollutants that are not adsorbed. Thus, all the prior art problems resulting from the presence of adsorbent material in the clarification elements, whatever they may be, are averted.

In particular, the quantities of sludge coming from the clarification are smaller than in the prior art. Since the sludge does not contain any adsorbent material, it is furthermore unnecessary to treat it in order to separate it. The costs of implementing the method of invention are therefore reduced relative to the costs entailed by the prior-art methods which entail the need to treat sludge coming from the clarification in order to retrieve the adsorbent material that it contains.

According to the invention, the content of the contact vessel is stirred only partially, a non-stirred area of the vessel being prepared in its lower part. Thus, a gradient of concentration of adsorbent material is created within the contact vessel. The used adsorbent granular material, with the added weight of the matter adsorbed therein, has its density increased. It thus collects in the lower part of the contact vessel. This used granular material can be purged from this lower part and replaced by fresh material without any interruption of the process.

The purged adsorbent material can be drained and stored in barrels which, once full, are conveyed to an external site in order to regenerate the adsorbent material that they contain by thermal means. The specific adsorbent material implemented in the context of the present invention can indeed be regenerated by thermal means without any treatment, apart from a simple preliminary draining.

The duration for which the adsorbent material is put into contact with water in the contact vessel will be chosen by those skilled in the art in such a way as to optimize the adsorption of the organic material and of the pollutants contained in this adsorbent material. In practice, this contact time will preferably be from 5 min to 20 min.

The concentration of adsorbent material in the contact vessel will be chosen by those skilled in the art according to the load in terms of organic material and pollutants of the water to be treated. In practice, preferably, the used adsorbent granular material is purged and replaced by fresh adsorbent granular material so as to maintain an average concentration of said adsorbent material in said contact vessel during the last step for putting into contact. This average concentration will vary according to the water to be treated.

Preferably, the method comprises a preliminary step for pre-filtering the water to be treated before it enters said reactor on a pre-filter having a cut-off threshold of 1 to 5 mm. Such a pre-filtering is aimed at ridding the water to be treated of the solids that might be trapped therein during the subsequent steps of the method.

According to one variant, the method comprises periodic steps for cleaning said screen by a cleansing method chosen from the group constituted by a backwashing method and a method of cleansing by air-blowing method. Thus, the clogging of the filter is avoided.

The method according to the invention could be implemented with numerous techniques of clarification. According to one interesting variant, this clarification comprises a step of coagulation of said water to be treated producing coagulated water, a step of flocculation of said coagulated water producing flocculated water, a step of decanting of said flocculated water producing clarified water and sludge, said steps of coagulation, flocculation and decanting by means of the invention being carried out in the absence of adsorbent granular material.

According to such a variant, the method enables savings in quantities of the flocculent (polymer) that has to be used as compared to the prior art in which the water to be clarified contained adsorbent material. Indeed, this material gets aggregated with polymer. In its absence, there is therefore a need for less polymer.

Also, according to one variant, said step of clarification by coagulation-flocculation-decanting also comprises a step for injecting a ballast, a step for treating said sludges in order to extract therefrom the essential part of the ballast that it contains and a step for recycling this ballast in said clarification step, said sludges containing no adsorbent granular material.

The invention also relates to a plant for implementing the method according to the invention, characterized in that it comprises:

a contact vessel provided with means for conveying water, means for discharging water by overflow and stirring means, said contact vessel receiving a mixture of water to be treated and adsorbent granular material;

clarifying means connected to said means for discharging by overflow;

characterized in that said adsorbent material is constituted by agglomerates of active carbon particles, said agglomerates having a mean size of 200 μm to 600 μm and a specific surface area of 800 to 1000 m²/g;

in that it includes a screen installed in the upper part of said vessel, said screen comprising a layer of porous material having a thickness of 1 to 5 mm, said material having a cut-off threshold of 100 μm to 200 μm;

in that said vessel has a lower part in the shape of a hopper, the extremity of said hopper being provided with purging means;

in that said stirring means of said contact vessel are designed so that they are able to stir the content of the upper part of said contact vessel without stirring the content of the lower hopper-shaped part.

In such a plant, the physical characteristics of the layer of porous material used to form the screen enable it to fulfil its function which is that of retaining the adsorbent granular material within the contact vessel while not retaining the non-adsorbed organic material within this vessel. This screen lets through the turbidity of the water while preventing the granular material from reaching the clarification means,

The small thickness of this layer, namely 1 mm to 5 mm, especially prevents filtration in its mass.

The shape of the hopper of the lower part of the contact vessel promotes the migration of used granular material in this part arid its extraction by the purging means provided at its extremity.

Preferably, the porous material used to form the screen is a high-density polyethylene (HDPE). Such a material has the advantage of being certified for use in food applications and also of standing up very well to chemical reagents in exceptional cases where these reagents have to be used for cleaning the screen.

According to one interesting variant, the layer of porous material forming said screen is organized as a tube-shaped or box-shaped structure, the filtering taking place from the exterior to the interior of the tube or the box, said means of discharging from said contact vessel being connected to the interior of the tube or the box. Such tubes or boxes have the advantage of being commercially available and of being easily replaced.

Also, according to one variant of the invention, said stirring means of said contact vessel include a blade rotor mounted so as to be vertically mobile in said vessel, means to make the speed of rotation of said rotor vary and means enabling the vertical position of the rotor in said vessel to be made to vary. Such means constitute preferred means so that, according to the method of the invention, the content of said contact vessel is stirred only partially so as to create a gradient of concentration of said adsorbent material within it, the bottom of said contact vessel constituting a non-stirred area.

Although the plant according to the present invention could include different means of clarification, said plant preferably comprises means for injecting coagulant into a coagulation area and means for injecting flocculent into this flocculation area for its use by coagulation-flocculation-decanting.

Preferably, it also comprises means for injecting ballast into said flocculation area and advantageously means for extracting sludge coming from said clarification means connected to means for treating said sludge enabling the extraction therefrom of the essential part of the ballast that it contains and means for distributing extracted ballast in said flocculation area.

List of Figures

The invention, as well as its different advantages, will be understood more clearly from the following description of a non-exhaustive embodiment and from the appended drawings, of which:

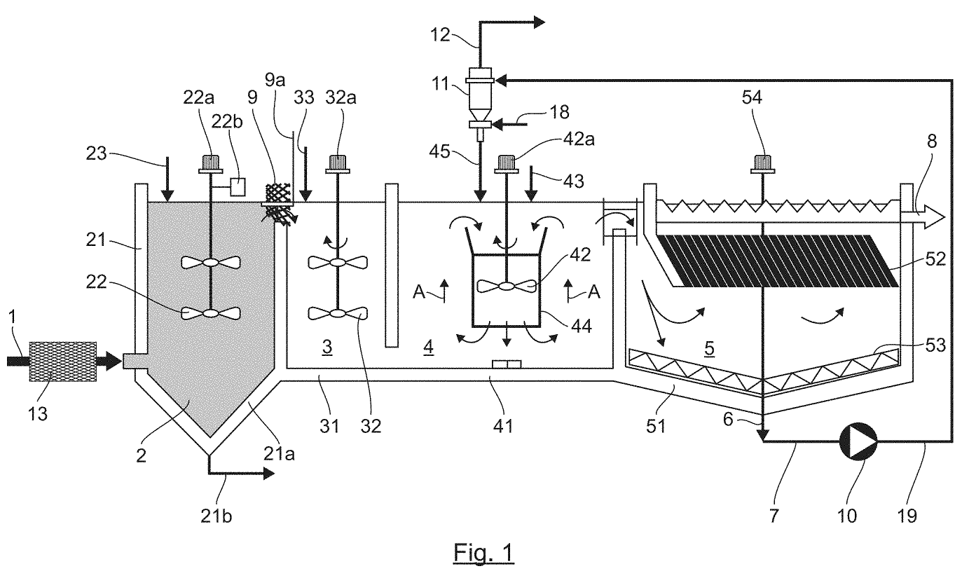

FIG. 1 represents a schematic view of a plant according to the invention;

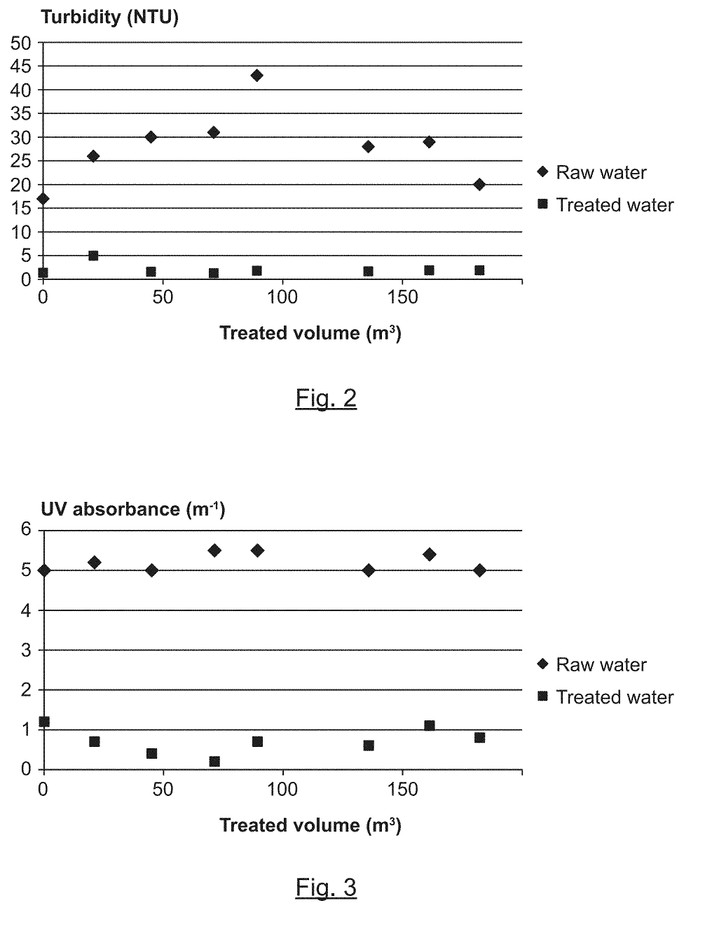

FIG. 2 is a graph indicating the turbidity of water in NTU before and after treatment according to the method of the invention in the plant represented in FIG. 1;

FIG. 3 is a graph indicating the UV absorbance of water at 254 nm before and after treatment according to the method of the invention in the plant illustrated in FIG. 1.

### EMBODIMENT OF ONE PLANT ACCORDING TO THE INVENTION

Referring now to FIG. 1, we present an embodiment of a plant according to the invention.

Such a water treatment plant comprises a pipe 1 for leading in raw water to be treated that reaches an area 2 for putting this water into contact with an adsorbent material.

On the lead-in pipe 1, pre-filter 13 constituted by metallic meshes is planned, This pre-filter, in the present embodiment, has a cut-off threshold of 1 mm.

The adsorbent granular material consists of agglomerates of activated carbon particles and is commercially distributed by the firm Chemviron under the name Microsorb (registered mark) 400 R. The agglomerates have an average size of 200 μm to 603 μm and an iodine index greater than 800 mg/g. Their specific surface area (N₂, BET method) is 900 m²/g. This granular adsorbent material can be regenerated by thermal means. This material can be led into the contact vessel 21 by means such as a dispenser 23.

The contact area 2 is demarcated by the walls of a contact vessel 21 having a lower hopper-shaped part 21a, the lower extremity of which is provided with purging means 21b. This contact vessel 21 houses stirring means comprising a blade stirrer, the rotation speed of which can be adapted by means of a motor 22a. Means 22b are also used to adjust the height of the stirring device in the contact vessel 21.

The contact vessel 21 communicates in an upper area with a coagulation area 3. At this level, there is a screen 9 constituted by a tube-shaped structure made from a 1 mm thick layer of a porous material made of high density polyethylene (HDPE) having a porosity of 150 μm. This screen is used to filter water travelling from the contact area 2 to the coagulation area 3.

It is fitted out with an air-inlet ramp 9a passing through the tubular structure making it possible, when necessary, to send air into the porous material in order to clean it efficiently.

The coagulation area 3 is demarcated by the contours of a coagulation vessel 31 which houses a stirrer 32 controlled by a motor 32a. Injection means, such as for example an injector 33, are used to inject a coagulant reagent, in this case ferrous chloride, into the coagulation area 3, at a rate of 20 ppm in the present embodiment. This coagulation area 3 communicates in a lower part with a ballasted flocculation area 4.

This ballasted flocculation area 4 is demarcated by the contours of a flocculation vessel 41 that houses a stirrer 42 controlled by a motor 42a. Injection means, such as for example an injector 43, are used to inject at least one flocculent reagent, in this case an anionic polymer, into the ballasted flocculation area, at a rate of 0.2 ppm in the present embodiment. Injection means 45 are also used to introduce ballast into the flocculation vessel 41. This ballast is constituted by an insoluble granular material denser than water, in this case micro-sand, in the present embodiment at a rate of 4.9 g/m³. This ballasted flocculation area 4 also houses a flow-guiding element which comprises an essentially tubular element 44 within which the stirrer 42 is made to rotate. The ballasted flocculation area 4 therefore constitutes a maturing area. It communicates in an upper part with a decanting area 5.

The decanting area 5 is demarcated by a decanting device 5:1 provided with the tilted blades 52 facilitating and accelerating the decanting process and a scraper 53 activated by a motor 54. The decanting device 51 has an underflow 6 that is linked to an extraction pipe 7 for extracting sludges containing ballast. It also has an overflow 8 for the discharge of treated water.

A pipe 19 and drawing-off or extraction means including a pump 10 enable this mixture to be conveyed to the inlet of a hydrocyclone 11.

The hydrocyclone 11 has an underflow that enables a mixture of ballast and a small quantity of sludge to be conveyed to the injection means 45. This underflow is linked to means 18 for injecting service water. This enables the injection of a mixture of ballast and diluted sludge into the ballasted flocculation area 4. It also has an overflow that is linked to a pipe 12 enabling the discharge of sludge rid of its ballast with a view to treatment to dehydrate and sanitize this sludge.

According to the invention, the plant does not have any means for the on-site recycling of this granular adsorbent material, this material being restricted within the contact vessel 21.

Example of One Method for Treating Water According to the Invention

A method for treating water according to the invention shall now be described with reference to the plant shown in FIG. 1.

Such a method consists of the conveyance, by the pipe 1, of water to be treated into the contact vessel 21 after it has been filtered by means of the pre-filter 13, in which it is put into contact with the granular adsorbent material indicated here above, in a proportion of 75 mg of material per liter of water. This concentration will vary especially according to the load of organic matter and pollutants in the water to be treated. This concentration enables the adsorption of a part of the organic material and of the pollutants contained in the water.

According to the invention, the content of the contact vessel 21 is stirred only in its median and upper part by the stirrer 22. To this end, the motor 22a and the means 22b for adjusting the height of the stirrer in the vessel are actuated so as to create a gradient of concentration of said adsorbent material within the contact vessel 21, the bottom of said vessel constituting a non-stirred area towards which there is a migration, owing to its increasing density, of the adsorbent granular material as and when it gets charged with organic and pollutant matter.

After sufficient contact time, the mixture of water and adsorbent granular material is introduced into the coagulation vessel 31 in travelling through the screen 9 in order to retain the adsorbent granular material in the contact vessel 21 while allowing its turbidity pass through.

In the coagulation vessel 31, the coagulating reagent is mixed with water. After a sufficient contact time, the mixture of water and coagulating reagent travels in the ballasted flocculation area 4 demarcated by the flocculation vessel 41. This mixture therein meets the flocculating reagent introduced by the application of the injection means 43 and micro-sand introduced by injection means 45.

The implementation of the flow guide 44 enables the creation of dynamic phenomena which give rise to movements of water represented by the arrows A. After maturing, the mixture coming from the ballasted flocculation area 4 travels into the decanting area 5 demarcated by the decanting device 51. The sludge containing ballast extracted in an underfloor 6 from the decanting device 51 by means of the pipe 7. The treated water is collected in an overflow 8 from this pipe. The sludge is recirculated towards the inlet of the hydrocyclone 11 by means of the pipe 19 and the pump 10.

The ballast is separated inside the hydrocyclone 11 from the rest of the sludge. It is extracted therefrom in an underflow and shed into the ballasted flocculation area 4. The rest of the sludge extracted in an overflow from the hydrocyclone 11 is discharged,

According to the invention, the used adsorbent granular material is drawn off from the contact vessel 21 by purging means 21b. This used material is drained and conditioned in barrels which, once they are filled, can be conveyed towards a unit for the thermal regeneration of adsorbent material. A renewal rate of 20 g/m³ is thus implemented.

Through the screen 9, the granular adsorbent material is retained in the contact vessel 2:1 and migrate neither into the devices situated downstream from this contact vessel nor, even less, into the treated water. The working of these devices therefore facilitated and the risk of finding granular material in the treated water is almost non-existent. Besides, the quantity of sludge produced at the exit from the decanting device is reduced and the action of the flocculent is optimized. The energy needed to recycle and treat this sludge coming from the decanter is also reduced. The quantity of sludge that is extracted from the hydrocyclone and has to be treated is also smaller.

The invention enables the efficient and stable reduction of the turbidity in terms of NTU of treated water as can be seen in FIG. 2. In practice, during tests the results of which are given in this FIG. 2, an average reduction of turbidity of 92% was observed.

The invention also efficiently reduces the organic matter contained in the treated water as can be seen in FIG. 3. In practice, during tests, the results of which are given in this figure, a mean reduction of 86% of the UV absorbance of treated water at 254 nm was observed. This result represents its organic matter content.

1-15. (canceled)

16. A method of treating water and removing organic matter and pollutants from the water comprising:
providing a thermally regenerable granular adsorbent material comprising agglomerates of active carbon particles having an average size of 200 μm to 600 μm and a specific area of 800-1000 m²/g;
directing the granular adsorbent material into a reactor;
directing the water to be treated into the reactor;
contacting the water with the granular adsorbent material contained in the reactor;
generating a concentration gradient of said granular adsorbent material in the reactor by partially stirring the water and granular adsorbent material in the reactor and creating a stirred area in an upper portion of the reactor and a non-stirred area in a lower portion of the reactor;
adsorbing organic matter and pollutants onto said agglomerates of active carbon particles that form the granular adsorbent material;
continuously or intermittently purging the granular adsorbent material from the non-stirred area of the reactor in order that the granular adsorbant material purged from the reactor can be subjected to thermal regeneration;
replenishing the purged granular adsorbent material in the reactor with fresh granular adsorbent material;
directing the water from the reactor to a downstream clarifier unit;
clarifying the water in the clarifier unit to produce clarified water and sludge; and
retaining the granular adsorbent material in the reactor and preventing the granular adsorbent material from flowing into the clarifier unit by screening the water leaving the reactor whereby said screening retains the granular adsorbent material in the reactor but permits organic matter to pass through the screening and to the clarifier unit.

17. The method of claim 16 further including:
contacting the granular adsorbent material with the water in the reactor for a period of 5 minutes to 20 minutes;
pre-filtering the water to be treated before the water to be treated reaches the reactor and wherein the pre-filtering includes a cut-off threshold of 1-5 mm; and
after the water leaves the reactor and before the water reaches the clarifier unit, adding a coagulant and a flocculant to the water and wherein the coagulant and flocculant are added to the water in the absence of the granular adsorbent material.

18. Method for treating water with a view to reducing its content in organic matter and pollutants, said method comprising:
a step for putting water to be treated into contact with a granular adsorbent material in a contact vessel provided with stirring means;
followed by a step for clarifying water coming from said vessel leading to the obtaining of clarified water and sludge;
characterized in that
said granular adsorbent material is constituted by agglomerates of active carbon particles, said agglomerates having an average size of 200 μm to 600 μm and a specific surface area of 800 to 1000 m²/g, said granular adsorbent material being regenerable by thermal means;
said water being filtered on a screen when exiting said vessel, before undergoing clarification, in order to retain said adsorbent granular material within said vessel while at the same time not retaining the non-adsorbed organic material on said adsorbent material,
and in that
the content of said contact vessel is stirred only partially so as to create a gradient of concentration of said adsorbent material within it, the bottom of said contact vessel constituting a non-stirred area;
used adsorbent granular material being purged continuously or intermittently from said non-stirred area of said contact vessel in order to be regenerated extemporaneously by thermal means, and replaced by fresh adsorbent granular material.

19. Method according to claim 18, characterized in that the contact time of the adsorbent material with the water in said contact vessel is from 5 minutes to 20 minutes.

20. Method according to claim 18 characterized in that the used adsorbent granular material is purged and replaced by fresh adsorbent granular material so as to maintain an average concentration of said adsorbent material in said contact vessel.

21. Method according to claim 18 characterized in that the method comprises a preliminary step for pre-filtering the water to be treated before it enters said reactor on a pre-filter having a cut-off threshold of 1 to 5 mm.

22. Method according to claim 18 characterized in that it comprises periodic steps for cleaning said screen by a cleansing method chosen from the group constituted by a backwashing method and a method of cleansing by air-blowing.

23. Method according to claim 18 characterized in that said step of clarification comprises a step of coagulation of said water to be treated producing coagulated water, a step of flocculation of said coagulated water producing flocculated water, a step of decanting of said flocculated water producing clarified water and sludge, said steps of coagulation, flocculation and decanting being carried out in the absence of adsorbent granular material.

24. Method according to claim 23 characterized in that said step of clarification comprises a step for injecting a ballast, a step for treating said sludges in order to extract therefrom the essential part of the ballast that it contains and a step for recycling this ballast in said clarification step, said sludges containing no adsorbent granular material.

25. A plant for treating water and removing organic matter and pollutants from the water comprising:
a reactor;
granular adsorbent material contained in the reactor, the granular adsorbent material contained in the reactor comprising agglomerates of active carbon particles having an average size of 200 μm-600 μm and a specific area of 800-1000 m2/g;
a water inlet communicatively connected to the reactor for directing the water to be treated into the reactor;
means for generating a concentration gradient of said granular adsorbent material in the reactor;
means for purging the granular adsorbent material from a bottom of the reactor;
means for replenishing fresh granular adsorbent material into the reactor;
means disposed at an outlet of said reactor for retaining said granular adsorbent material in the reactor and for permitting organic material to flow from the reactor;
wherein the means for retaining the granular adsorbent material comprises a screen installed in an upper portion of said reactor, said screen comprising a layer of porous material having a thickness of 1-5 mm and said porous material having a cut-off threshold of 100 μm-200 μm; and
a clarifier unit disposed downstream of the reactor for receiving water treated in the reactor and for producing a clarified effluent and sludge.

26. The plant of claim 25 wherein the reactor includes an upper stirred area and a lower non-stirred area and wherein the granular adsorbent material is purged from the lower non-stirred area.

27. Plant according to claim 25 characterized in that said porous material is an HDPE.

28. Plant according to claim 25 characterized in that the layer of porous material forming said screen is organized as a tube-shaped or box-shaped structure, the filtering taking place from the exterior to the interior of the tube or the box, said means of discharging from said vessel being connected to the interior of the tube or the box.

29. The plant according to claim 25 including a pre-filter located upstream of the reactor and wherein the pre-filter has a cut-off threshold of 1 mm-5 mm.

30. The plant of claim 25 including at least one flocculation tank interposed between the reactor and said clarifier unit for receiving and mixing a ballast with the water being treated and wherein the plant includes means for injecting a ballast into the flocculation tank.

31. The plant of claim 30 including means for extracting sludge from the clarifier unit and means for separating said ballast from the sludge and for recirculating the ballast into the flocculation tanks interposed between the reactor and the clarifier unit.
